(19) United States
(12) Patent Application Publication
(10) Pub. No.: US 2026/0341982 A1
(43) Pub. Date: Oct. 29, 2026

(54) LUG AND SPLICE SYSTEMS FOR CONDUCTORS

(71) Applicant: ERICO International Corporation, Solon, OH (US)

(72) Inventors: Marianna Palmer, Chesterland, OH (US); Nicholas Michael Camburako, Streetsboro, OH (US); Thomas Edward Bendlak, Macedonia, OH (US); Thomas Bockstoce, Akron, OH (US); William Hiner, Solon, OH (US)

(21) Appl. No.: 19/659,386

(22) Filed: Apr. 27, 2026

Related U.S. Application Data
(60) Provisional application No. 63/794,882, filed on Apr. 25, 2025.
(60) Provisional application No. 63/848,580, filed on Jul. 22, 2025.
(60) Provisional application No. 63/985,392, filed on Feb. 18, 2026.

(51) Int. Cl. H01R 4/40; H01R 11/12; H01R 43/027

(52) U.S. Cl. CPC H01R 4/40; H01R 11/12; H01R 43/027

(57) ABSTRACT

An assembly for securing a conductor can include a lug. The lug can include a base and sidewalls extending from the base to define a conductor channel that extends along the base. A locking lever can have a proximal end that engages the sidewalls to secure the locking lever to be pivotable relative to the base. A threaded fastener can be secured to the base and can extend through a distal end of the locking lever to provide a force that pivots the distal end of the locking lever towards the base to secure the conductor within the conductor channel.

### CROSS-REFERENCE TO RELATED APPLICATIONS

This application claims priority to U.S. Provisional Application No. 63/985,392, filed Feb. 18, 2026, U.S. Provisional Application No. 63/848,580, filed Jul. 22, 2025, and U.S. Provisional Application No. 63/794,882, filed Apr. 25, 2025, each of which is hereby incorporated by reference in its entirety.

### BACKGROUND

In some electrical grids, high-to-low voltage transformers or other electrical modules can supply power to power distribution modules, which may distribute the power to individual power taps or access points. For example, a transformer can be linked to a power distribution module (e.g., a cabinet) that supplies power to the lights, outlets, and any other electronic devices in a residential home or a commercial space. Similarly, other transmission of low voltage power between modules may also be useful in a variety of contexts.

### SUMMARY

Some examples of the disclosed technology include an assembly for securing a conductor that can include a lug. The lug may include a base and sidewalls extending from the base to define a conductor channel that extends along the base between first and second ends of the conductor channel. The assembly can also include a locking lever having a proximal end that engages the sidewalls to secure the locking lever to be pivotable relative to the base, and a threaded fastener secured to the base and extending through a distal end of the locking lever to provide a force that pivots the distal end of the locking lever towards the base to secure the conductor within the conductor channel.

Some examples of the disclosed technology include an assembly for securing a conductor that can include a lug including a base and sidewalls that define a conductor channel configured to receive a conductor so that an axis of the conductor extends along a first direction between first and second ends of the conductor channel. The conductor channel may be open to receive the conductor into the conductor channel via movement of the conductor into the conductor channel transverse to the first direction. The assembly can also include a locking lever rotatable relative to the sidewalls to clamp the conductor onto the base within the conductor channel.

Some examples of the disclosed technology include a method for securing a conductor that can include providing a lug that includes a base and sidewalls extending from the base to define a conductor channel that extends along the base between first and second ends of the conductor channel. The conductor may be inserted into the conductor channel. A proximal end of a locking lever may be engaged with the sidewalls to secure the locking lever for pivoting movement relative to the base. A force can be provided that pivots the distal end of the locking lever towards the base to secure the conductor within the conductor channel using a threaded fastener that is secured to the base and extends through a distal end of the locking lever.

### BRIEF DESCRIPTION OF THE DRAWINGS

The accompanying drawings, which are incorporated in and form a part of this specification, illustrate examples of the disclosed technology and, together with the description, serve to explain the principles of examples of the disclosed technology:

FIG. 1 is a schematic view of a power distribution system according to an embodiment of the invention;

FIG. 2 is a side view of a connector with a locking lever of the power distribution system of FIG. 1;

FIG. 3 is a side view of the connector and locking lever of FIG. 2, with a screw and a cross beam installed;

FIGS. 4A-4D illustrate an example removal (or installation) method of the locking lever for the connector of FIG. 2;

FIGS. 5A-5C are example locking levers for the connector of FIG. 2;

FIG. 6 is an axonometric view of another cross beam configuration for the connector of FIG. 2;

FIGS. 7A and 7B are example base configurations for the connector of FIG. 2;

FIG. 8 is a side cross-sectional view of the connector of FIG. 2 having a conductor stop, according to another embodiment of the invention;

FIG. 9 is an axonometric view of another example connector of the power distribution system of FIG. 1;

FIG. 10 is a side view of an example locking lever for the connector of FIG. 9;

FIG. 11 is an axonometric view of the connector of FIG. 9 and the locking lever of FIG. 10 in an installed configuration;

FIG. 12 is a side view of another example locking lever for the connector of FIG. 9;

FIG. 13 is a side view of another example locking lever for the connector of FIG. 9;

FIG. 14 is an axonometric view of the connector of FIG. 9 and the locking lever of FIG. 13 in an installed configuration;

FIGS. 15A and 15B are side views of the connector of FIG. 9 and the locking lever of FIG. 13 in two installed configurations;

FIG. 16 is an axonometric view of another example connector of the power distribution system of FIG. 1;

FIG. 17 is an axonometric view of the connector of FIG. 16 with a locking lever installed;

FIG. 18A is a side view of the locking lever of FIG. 17 in a first installed position;

FIG. 18B is a side view of the locking lever of FIG. 17 in a second installed position;

FIGS. 19A and 19B are side views of the locking lever of FIG. 17 in the second installed position, illustrating actuation of the locking lever to secure a conductor;

FIG. 20 is a side elevation view of another example connector of the power distribution system of FIG. 1;

FIG. 21 is a side elevation view of another example connector of the power distribution system of FIG. 1; and

FIGS. 22A-22B are side elevation views of another example connector of the power distribution system of FIG. 1, shown with a locking lever in a first and a second installed position.

### DETAILED DESCRIPTION

Before any examples of the disclosed technology are explained in detail, it is to be understood that the disclosed technology is not limited in its application to the details of construction and the arrangement of components set forth in the following description or illustrated in the following drawings. The disclosed technology is capable of other implementations and of being practiced or of being carried out in various ways.

The following discussion is presented to enable a person skilled in the art to make and use examples of the disclosed technology. Various modifications to the illustrated examples will be readily apparent to those skilled in the art, and the generic principles herein can be applied to other examples and applications without departing from examples of the disclosed technology. Thus, the disclosed technology is not intended to be limited to examples shown, but is to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives and fall within the scope of examples of the disclosed technology.

As noted above, in some contexts, it may be useful to electrically link a high-to-low voltage transformer to a power distribution module or otherwise provide for transmission of low voltage electrical power between different electrical modules (e.g., between known types of low-voltage equipment or enclosures). Examples of the disclosed technology can be useful for this purpose, and others.

For example, some implementations of the disclosed technology may include a connector (e.g., a lug assembly or a splice assembly) that can securely connect low voltage or other conductors together (e.g., in series) or to other components along a power transmission path. In particular, some examples can secure low voltage conductors with oblong cross-sections (e.g., conductors formed from braided wires with generally rectangular exterior cross sectional profiles) or with various other profiles. In some examples, disclosed lug and splice assemblies can securely connect conductors in a variety of configurations (e.g., stacked configurations), with corresponding benefits for adaptability to particular facilities. In some examples, particularly compact and mechanically robust lug and splice assemblies can be provided, including through selective location of fastening structures to secure a lug or a splice to a support structure or to secure one or more conductors to the lug or the splice (e.g., via clamping by included threaded fasteners).

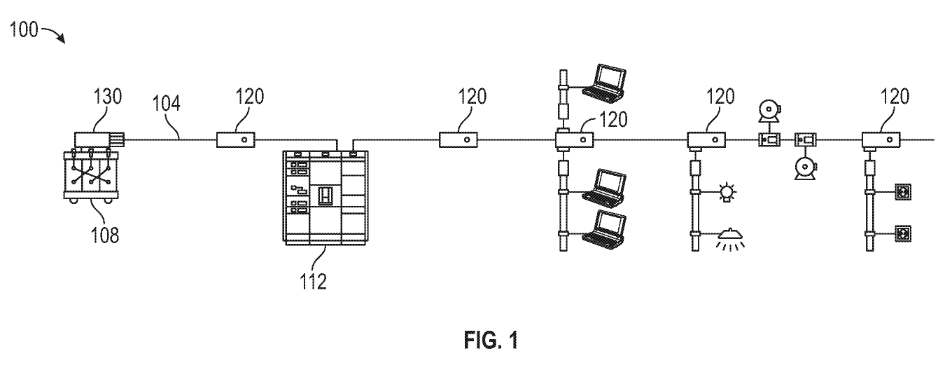

FIG. 1 illustrates an example of a power distribution system 100 configured to distribute power from an electrical grid to various electrical components (e.g., end-use devices such as laptops, cameras, lighting fixtures, and other equipment), according to some examples of the disclosed technology. Although examples of the disclosed technology can be used in other settings, including industrial, commercial, and residential applications, implementation in the illustrated configuration may be particularly advantageous in some cases. In the illustrated embodiment, the power distribution system 100 includes a set of low voltage power conductors 104 that are attached to a transformer 108 and a power distribution module 112 (e.g., switch cabinet, panelboard, or other known distribution system) at respective attachment points for each of the conductors 104 at the transformer 108 and the power distribution module 112, respectively.

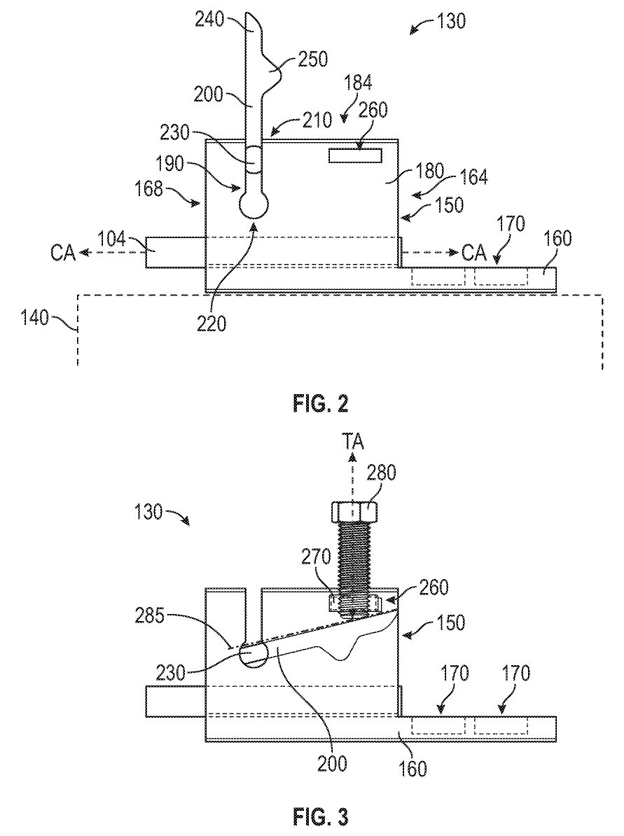

As illustrated herein (see, e.g., FIG. 2), the conductors 104 are presented partly schematically, with oblong, generally rectangular conductive elements and surrounding insulation, although other configurations are possible (e.g., having a circular profile). In particular examples, the conductors 104 can be braided or other conductors with oblong cross-sections. For example, the conductors 104 can be braided, oblong, insulated conductors, rated for particular voltage or current capacities. The use of a lug assembly and splice assemblies as described herein may be particularly advantageous with braided oblong conductors, with regard to security of attachment and adaptability of installation. Correspondingly, the details discussed herein relative to the disclosed lug and splice assemblies may in some cases both complement and extend the advantages of such conductors relative to installation and service. However, as also noted above, the disclosed assemblies can be used with a variety of conductor types and profiles, including round conductors or conductors having other cross-sectional geometries.

In the illustrated example, the low voltage power conductors 104 electrically link the power distribution module 112 to the transformer 108, which is connected to the power grid, and thereby can supply power to the power distribution module 112. From the power distribution module 112, power can then be distributed to other electronics over various types, including by using conductors similar to the conductors 104 or others.

In some cases, a particular power conductor may not be long enough to connect the transformer 108 with the power distribution module 112 (or to connect other relevant components). Further, even where longer conductors can be used, these can be heavy, bulky, and difficult to install, particularly in confined spaces or when routing around existing infrastructure. Moreover, use of shorter conductor lengths overall may provide increased adaptability of conductor systems to the needs of a particular installation, including relative to changes over time.

The power distribution system 100 may thus include a plurality of connection nodes that include splice assemblies 120 to connect corresponding lengths of the conductors 104 (and, correspondingly, various branches or other structures of the system 100 at large). Accordingly, the splice assemblies 120 can allow the use of shorter (and more maneuverable) lengths of conductors, for improved overall efficiency and adaptability in installation operations. Further, the splice assemblies 120 can allow highly adaptable expansion of overall reach or complexity of a conductor assembly, e.g., to accommodate for demand growth or other changes over time. For example, appropriately configured installations of the splice assemblies 120 may allow for efficient expansion of the numbers of nodes, branches, or connected sub-systems for the system 100, or for efficient general extension of total conductor length of the system 100. Additionally, the splice assemblies 120 can facilitate maintenance and repair operations by allowing for isolation and replacement of individual conductor segments without requiring replacement of entire conductor runs, and can simplify troubleshooting by providing accessible connection points for testing and inspection along the power distribution path.

The power distribution system 100 also includes a connector (e.g., lug) 130 to mechanically and electrically connect the transformer 108 to the low voltage power conductor 104. Use of the lug 130 in the power distribution system 100 ensures a reliable and efficient electrical connection between the low power conductor 104 and the transformer 108, and allows for quick installation and maintenance, as will be further detailed below. Further, as also noted below, the lug 130 (or other similar lugs) can be used to connect the conductors 104 to other equipment, as needed.

FIG. 2 illustrates an example configuration of the connector 130 as a mechanical lug 130 used in the power distribution system 100. As noted above, the lug 130 secures the end of the conductor 104 for connection to a fixed installation, such as a palm 140. In some examples, the palm 140 may be a conductive mounting surface or terminal pad associated with the transformer 108, the power distribution module 112, or other electrical equipment, providing both mechanical support and electrical continuity for the conductor 104, although other configurations are possible. Although a lug is shown in the corresponding examples, the following discussion equally applies to similarly configured components of a splice or other connector.

In particular, the mechanical lug 130 as illustrated includes a support body that defines a conductor channel 150 configured to receive the conductor 104. As shown, the conductor channel 150 has a rectangular profile, although other configurations are possible (e.g., other profiles adapted to circular or other conductor cross-sections). The conductor channel 150 extends along a base 160 between a first end 164 and second end 168 of the channel 150. When the conductor 104 is installed within the channel 150, a conductor axis CA of the conductor 104 extends along a first direction between the first end 164 and the second end 168 (e.g., along an elongate direction of the conductor channel 150).

To support mounting of the lug 130, the base 160 can protrude beyond the channel 150, which can provide additional surface area for mounting hardware and structural support. For instance, the base 160 has recessed mounting holes 170 that attach the lug 130 to the palm 140 (e.g., shown in dashed relief in FIG. 2). As shown, the recessed mounting holes 170 are disposed along the base 160 within and outside of the channel 150. Thus, for example, users may be able to more easily install the base 160 onto a palm or other support structure, even after the conductor 104 is secured within the channel 150, as the mounting holes 170 outside the channel 150 remain accessible regardless of conductor placement. In other examples, the recessed mounting holes 170 may be positioned along the base 160 only within the channel 150 or only outside of the channel 150, depending on installation requirements or space constraints of a particular application. Further, the size of the base 160 can be narrower (e.g., laterally) than conventional designs so as to save space during installation to the palm 140, which can be particularly advantageous in confined installation environments or when multiple lugs must be positioned in close proximity.

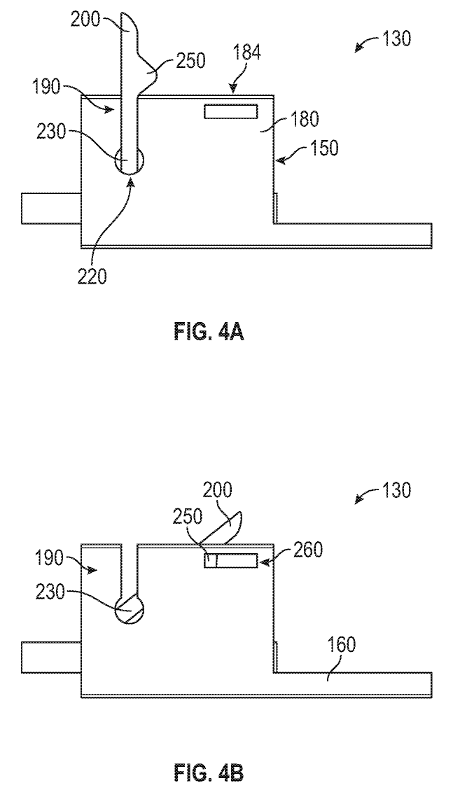

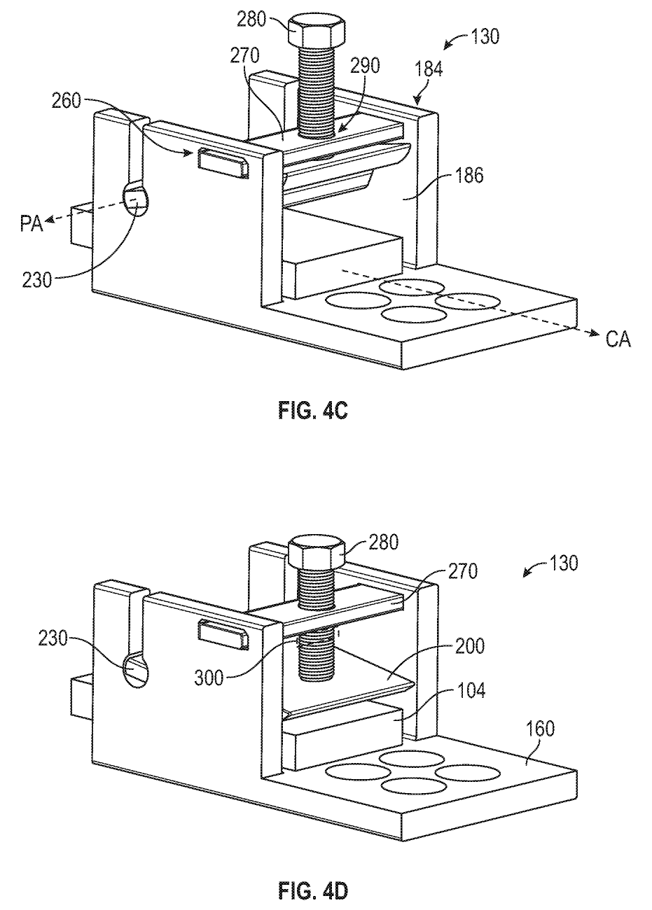

As also shown in FIG. 2, sidewalls 180 extend from the base 160 (e.g., in parallel) to further define the channel 150. As shown, for example, the sidewalls 180 can extend from the base 160 as first and second sidewalls, spaced laterally apart from each other (e.g., arranged as laterally-spaced left and right sidewalls in the orientation shown). In particular, the sidewalls 180 have distal ends 184 opposite the base 160, with an open side 186 (see FIG. 4C) positioned between the distal ends 184 of the sidewalls 180 to receive the conductor 104 into the conductor channel 150. In this way, the sidewalls 180 and the base 160 together define the channel 150, and can allow for lay-in installation of the conductor 104, as will be further detailed below.

To secure a conductor within the channel 150, the sidewalls 180 are configured to removably secure a securing mechanism (e.g., a locking lever). For example, the sidewalls 180 as shown have slots 190 that slidably receive and secure a locking lever 200 to enclose the channel 150. In particular, each slot 190 has an opening 210 that receives the locking lever 200 and terminates in a pivot opening 220, opposite the opening 210. The pivot opening 220 has a bulbous profile such that the pivot opening 220 is larger in width than the slot 190 and the opening 210, which can allow pivoting movement of the locking lever 200 as further detailed below. Thus, for example, when pivoted toward the base 160, the locking lever 200 extends between the sidewalls 180 and closes the open side of the conductor channel 150 opposite the base 160, thereby enclosing and securing the conductor 104 within the channel 150 between the locking lever 200 and the base 160.

Referring still to FIG. 2, the locking lever 200 has a proximal end 230 and a distal end 240. In this example, the proximal end 230 can include protruding, oblong tabs as shown, or can be otherwise structured for removable and rotatable engagement with the sidewalls 180. To install the locking lever 200, the proximal end 230 is received within the slots 190 and advanced into the pivot opening 220. When fully installed, the proximal end 230 defines a pivot axis PA (see FIG. 4C) about which the locking lever 200 pivots during clamping operations. The bulbous profile of the pivot opening 220 accommodates the proximal end 230 for rotational movement, while the narrower slot 190 prevents withdrawal of the locking lever 200 except at a specific release orientation (e.g., with the lever 200 extending substantially vertically, as shown), thereby securing the locking lever 200 for pivoting movement relative to the base 160 with the pivot axis PA extending through the laterally opposed pivot openings 220.

To secure the locking lever 200 to the conductor 104, the locking lever 200 has an engagement portion (e.g., a protrusion 250) positioned at a spacing from the proximal end 230 (e.g., between the proximal end 230 and the distal end 240). In use, the locking lever 200 is configured to be rotated about the pivot opening 220 between the sidewalls 180 towards the base 160 so that the protrusion 250 (or other engagement portion) contacts and clamps the conductor 104 to the base 160.

In particular, in the illustrated example, as the locking lever 200 rotates about the pivot axis PA, the protrusion 250 follows an arcuate path toward the base 160, and the protrusion 250 translates this rotational movement into progressively increasing normal force against the conductor 104. In this way, a cam-like engagement of the conductor 104 can be provided, with the cam-like (e.g., rounded) profile of the protrusion 250 providing self-locking characteristics that can resist loosening under vibration.

To secure the locking lever 200 in engagement with a conductor, a fastener can be used. For example, apertures 260 on the sidewalls 180 adjacent the opening 210 receive a cross beam 270 that extends laterally across the channel 150. In particular, turning now to FIG. 3, when the locking lever 200 is rotated to be below the apertures 260 (e.g., represented by plane 285), the cross beam 270 can be installed within the apertures 260. When installed, the cross beam 270 can receive a screw 280 through a corresponding receiving hole 290 (see FIG. 4C) in the cross beam 270, with the screw 280 aligned to engage the locking lever 200. In some examples, the locking lever 200 and the cross beam 270 are made of a durable material, such as aluminum or steel, to achieve a higher clamping force from applied torque on the screw 280. In some examples, the cross beam 270, in particular, may be formed from relatively high strength material, such as hardened steel or stainless steel, to provide enhanced clamping force and resistance to deformation under repeated torque application cycles.

Thus, in general, the screw 280 can be advanced (relative to the cross beam 270) towards the base 160 along a thread axis TA of the screw 280 (i.e., an axis corresponding to a bulk direction of a nut or the cross beam 270 during threaded advancement along the screw 280), to clamp the conductor 104 to the base 160 within the channel 150. In this way, the protrusion 250 of the locking lever 200 can create a relatively uniform contact pressure with the conductor 104, with high clamping force, and with a requirement of relatively minimal loose hardware (e.g., one screw 280).

In some examples, referring again to FIG. 2, once the lug 130 is attached to the palm 140 (e.g., via recessed mounting holes 170), a user can then install the conductor 104 into the channel 150, and secure the conductor 104 indirectly to the palm 140 by installing the locking lever 200. To further secure the lug 130 to the palm 140, the screw 280 on the cross beam 270 can then be advanced toward the base 160 to clamp the conductor 104 in place onto the base 160 (e.g., to directly clamp the conductor 104 onto the base 160, without intervening components). This sequence of operations allows the lug 130 to be pre-positioned and secured to the palm 140 before conductor installation, which can be advantageous in installations where access to the mounting holes 170 may be limited after the conductor 104 is in place.

Alternatively, installation can be performed by first installing the conductor 104 to the lug 130 and then subsequently attaching the lug 130 to the palm 140. In both cases, a user can install the conductor 104 with a lay-in installation, in which the conductor 104 is moved into the channel 150 transverse to the conductor axis CA, transverse to a corresponding end-to-end direction of the channel 150, and transverse to the lateral direction between the sidewalls 180. This lay-in approach can generally improve ease of installation and servicing, as compared to conventional methods, including where other system structure or characteristics limit access to the ends of the conductor channel 150 or makes axial (stabbing) insertion of the conductor 104 impractical. Further, as also noted above, similar operations can be used to splice together multiple conductors (e.g., to also be connected to a palm or other support by a common clamping force from the lever 200).

An example method of securing the conductor 104 to the lug 130 is shown in FIGS. 4A-4D. As illustrated in FIG. 4A, the conductor 104 has been received within the channel 150 (e.g., via a lay-in installation) and the locking lever 200 has been fully inserted into the slot 190 so that the proximal end 230 of the locking lever 200 is contained within the pivot opening 220. In this position, the protrusion 250 of the locking lever 200 is aligned with the distal ends 184 of the sidewalls 180 of the lug 130, which can give visual feedback to a user to indicate that the locking lever 200 is fully installed. In other arrangements, however, other configurations are possible.

In FIG. 4B, the locking lever 200 is advanced (e.g., pivoted) towards the base 160, within the channel 150 between the sidewalls 180. In this position, the protrusion at the proximal end 230 secures the locking lever 200 between the sidewalls 180 so that the locking lever 200 is allowed to rotate but cannot be accidentally removed from the slot 190. In particular, in the example illustrated, the locking lever 200 is only allowed to be removed and installed into the slot 190 when in a substantially vertical orientation (e.g., substantially parallel to the slot 190), such as shown in FIG. 4A and described above.

Referring now to FIG. 4C, once the locking lever 200 has been advanced past the apertures 260 (e.g., see FIG. 3) towards the base 160, the cross beam 270 can be installed within the apertures 260 of the sidewalls 180 and the screw 280 can be received within the receiving hole 290. Once the cross beam 270 has been installed and the screw 280 is received within the receiving hole 290, as shown in FIG. 4D, the screw 280 can then be advanced towards the base 160 until the protrusion 250 of the locking lever 200 contacts the conductor 104 so as to clamp the conductor 104 to the base 160. In this way, the screw 280 can be advanced through the cross beam 270 until a desired torque requirement is achieved, corresponding to a desired clamping force.

To further secure the screw 280 to the cross beam 270 and maintain the locking lever 200 in place, a nut 300 (e.g., shown in dashed lines) can be installed either above or below (e.g., as shown) the cross beam 270 to secure the screw 280 relative to the cross beam 270, and further secure the locking lever 200 relative to the conductor 104. In this way, the nut 300 can also serve as a locking mechanism that resists loosening due to vibration or thermal cycling during operation.

The clamping characteristics of the locking lever 200 can be influenced by the profile or positioning of the protrusion 250 relative to the pivot axis PA and the fastener-engagement location (e.g., where the screw 280 contacts the locking lever 200). In the configuration shown in FIGS. 4A-4D, the protrusion 250 is positioned between the pivot axis PA and the screw 280 along the elongate direction of the locking lever 200 (e.g., along the direction of the lever arm between the pivot axis PA and an opposed free end). This arrangement creates a lever arm along the elongate direction of the lever 200, by which the torque applied by the screw 280 is translated into amplified clamping pressure at the protrusion 250. Accordingly, the distance from the pivot axis PA to the protrusion 250, relative to the distance from the protrusion 250 to the fastener-engagement location, defines a lever ratio that determines the degree of force amplification.

In some examples, the protrusion 250 may be positioned closer to the pivot axis PA than to the fastener-engagement location, which can increase mechanical advantage for clamping. Alternatively, the protrusion 250 may be centered or positioned closer to the fastener-engagement location depending on desired clamping characteristics for a particular application, although other configurations are possible.

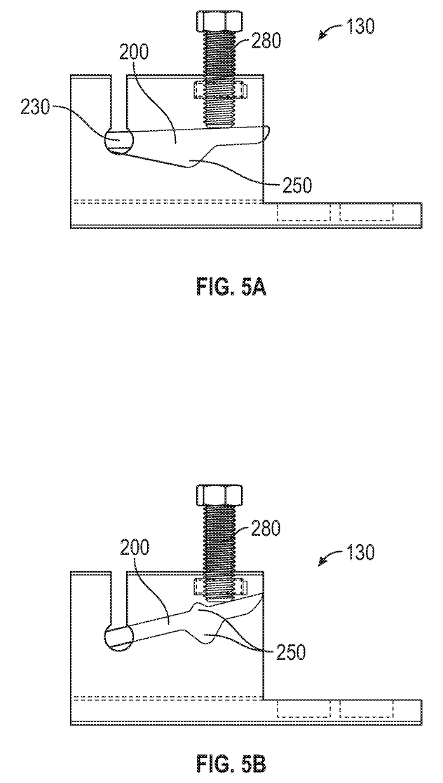

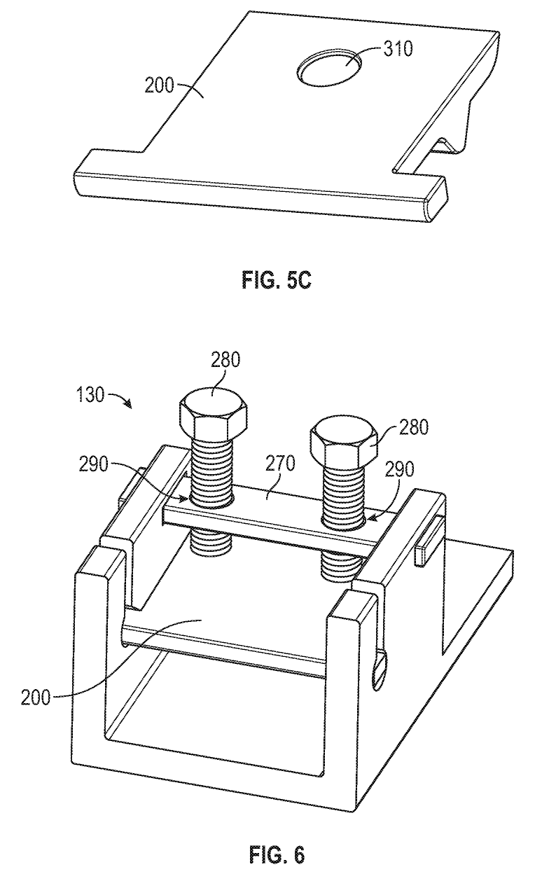

FIGS. 5A-5C illustrate different lever shapes, according to other examples (e.g., for use in the lug 130). In particular, as shown in FIG. 5A, the protrusion 250 of the locking lever 200 has a gradual slope between the proximal end 230 and where the screw 280 contacts the locking lever 200. In this embodiment, the contact surface area between the locking lever 200 and the conductor 104 is increased so as to provide a more uniform pressure distribution when in contact with the conductor 104. In another embodiment, the protrusion 250 can be more rounded to have a more circular profile.

In FIG. 5B, the protrusion 250 of the locking lever 200 is double sided (e.g., so as to contact the conductor 104 on one side and the screw 280 on the other side when installed). In this embodiment, the locking lever 200 may be reversible such that the locking lever 200 can be installed in either orientation (e.g., with each protrusion 250 on either side being enabled to clamp the conductor 104). In this way, the locking lever 200 can accommodate and secure different thicknesses of conductors 104 without having to increase the height of the sidewalls 180. The double-sided configuration can also reduce inventory requirements by allowing a single locking lever design to serve multiple installation scenarios. Further, the upper protrusion 250 can help to prevent slippage of the screw 280 relative to the locking lever 200.

FIG. 5C illustrates an example locking lever 200 with a dimple 310 in a top of the locking lever 200. In this example, the dimple 310 in the locking lever 200 guides and receives the screw 280 (see FIG. 5B) during installation, to help prevent the screw 280 from becoming misaligned when advanced towards the base 160. The dimple 310 can have a conical, hemispherical, or other concave profile that corresponds to the tip geometry of the screw 280, providing self-centering engagement as the screw 280 is initially positioned. In other examples, other recesses, protrusions, or other retention structures can be similarly provided to help maintain alignment of the screw 280.

FIG. 6 illustrates another embodiment of a cross beam 270 for use in the lug 130. In particular, in this embodiment, the cross beam 270 has two receiving holes 290 configured to receive two screws 280. In this example, the locking lever 200 has a wider load distribution onto the conductor as the screws 280 are advanced that reduces the stress applied only to a middle of the conductor 104, as compared to single screw configurations. In this way, a more uniform amount of force can be applied to the locking lever 200 during installation. The dual screw arrangement can be particularly advantageous for wider conductors or for applications requiring higher clamping forces. Additionally, the spacing between the two receiving holes 290 along the cross beam 270 can be selected to correspond with structural features of the locking lever 200, such as reinforced regions or contact surfaces, to optimize force transmission from the screws 280 through the locking lever 200 to the conductor 104.

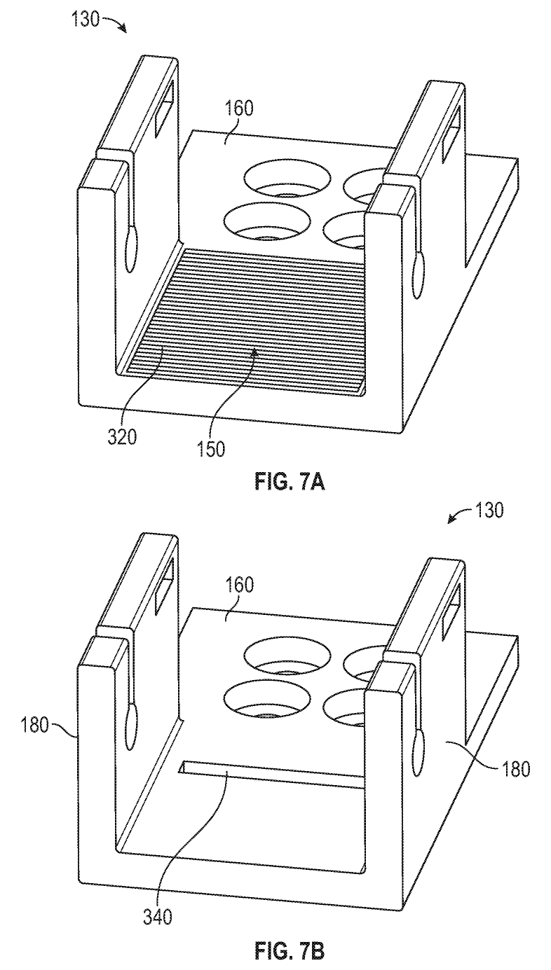

FIGS. 7A and 7B illustrate different base configurations of the lug 130. In particular, as shown in FIG. 7A, the base 160 of the lug 130 has a textured support surface 320 within the channel 150 so as to create friction between the conductor 104 and the base 160 when installed. This, in turn, can improve the tensile pullout strength of the lug 130 for a particular conductor. In this example, the textured surface 320 may be integrally formed during manufacturing, such as through knurling, machining, or extrusion processes that create a pattern of ridges, grooves, or other surface irregularities. In some examples, the textured support surface 320 can include a crosshatch pattern, parallel ridges extending transverse to the conductor axis direction, or a series of raised points or dimples that increase the coefficient of friction between the conductor 104 and the base 160. The textured support surface 320 can be particularly advantageous for use with braided conductors, where the textured pattern can interlock with the woven strands of the conductor 104 to further resist axial displacement under tensile loading.

Referring now to FIG. 7B, the base 160 of the lug 130 has a groove 340 (e.g., V-shaped or U-shaped) positioned below where the protrusion 250 of the locking lever 200 is received when advanced towards the base 160 to contact a conductor. In this embodiment, the protrusion 250 is able to deform the conductor 104 into the groove 340 to further improve tensile pullout strength of the lug 130. In some examples, the groove 340 can be integrally formed during manufacturing, such as through extrusion or machining processes, and can extend transversely across a width of the conductor channel 150 (e.g., between the sidewalls 180). The depth and profile of the groove 340 can be selected to correspond with the geometry of the protrusion 250, such that clamping force applied by the locking lever 200 causes controlled deformation of the conductor 104 into the groove 340 without damaging the conductor strands.

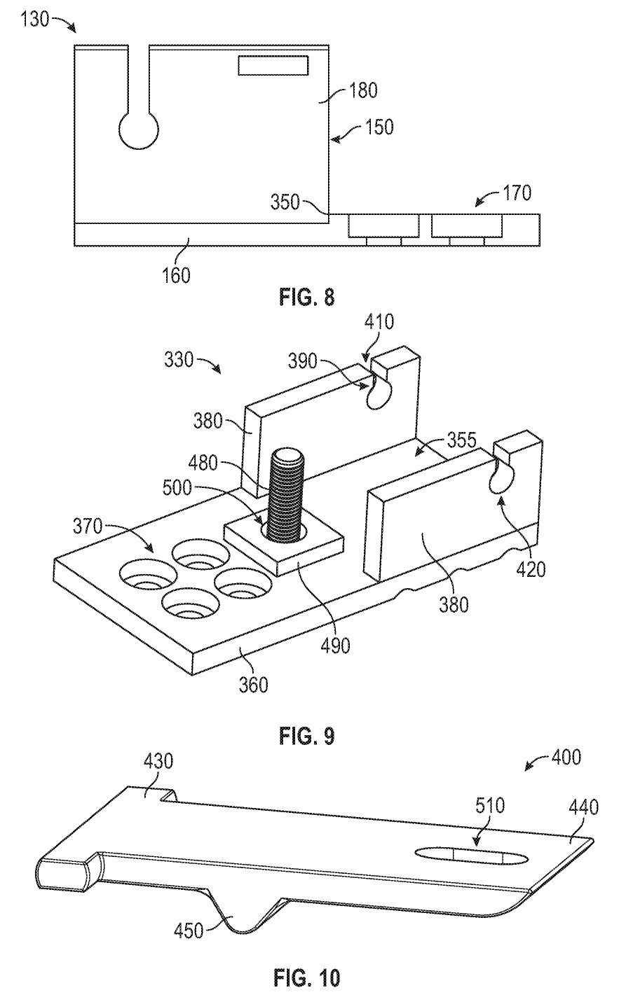

FIG. 8 illustrates another example of the lug 130, according to another embodiment of the design. In particular, a stop 350 is machined, extruded, or otherwise formed on the base 160 during manufacturing, between the sidewalls 180 and the channel 150. The stop 350 can provide a visual and tactile feedback to a user indicating that the conductor 104 has been installed far enough within the channel 150. The stop 350 creates a mechanical boundary that also prevents the conductor 104 from extending past the sidewalls 180 and onto the recessed mounting holes 170 so as to hinder the attachment of the lug 130 to the palm 140 and to prevent the conductor 104 from contacting the hardware. In some examples, this and other features discussed herein may be particularly useful for oblong (e.g., rectangular) conductors, particularly oblong braided conductors. However, other installations may secure other types of conductors (e.g., multiple round conductors).

FIG. 9 shows a connector configured as a mechanical lug 330, as another configuration of the lug 130 that can secure an end of one or more of the conductors 104 (see FIG. 1) to a fixed installation, e.g., the palm 140. As shown, the lug 330 is generally similar to the lug 130, and discussion of the lug 130 above accordingly applies to the lug 330 unless otherwise indicated. For example, similarly to the lug 130, the lug 330 has a conductor channel 355, a base 360 that protrudes beyond the channel 355, and mounting holes 370 that can attach the lug 330 to the palm 140. Furthermore, the lug 330 has laterally spaced sidewalls 380 that extend upwardly from the base 360 and have slots 390 that receive and secure a locking lever (e.g., any of the configurations of a locking lever 400 discussed below). The slots 390 have an opening 410out of the sidewalls 380, opposite a pivot opening 420 that forms a blind end of the slots 390.

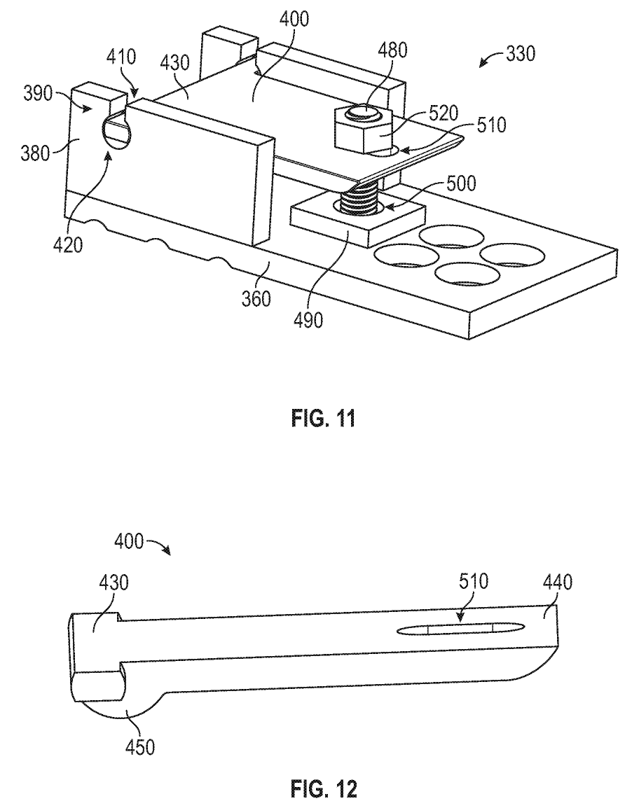

As shown in FIG. 10, in one example, the locking lever 400 has a proximal end 430 having protrusions to guide pivoting movement (e.g., protruding, oblong tabs, as shown). As shown in FIG. 11 and similarly discussed for preceding examples, the tabs are received within the slots 390, to removably secure the locking lever 400 for pivoting movement relative to the sidewalls 380. Additionally, a threaded fastener configured as a bolt 480 engages the locking lever 400 to rotate and hold the locking lever 400, to secure the conductor 104 onto the base 360.

As one example difference relative to the lug 130, in the illustrated embodiment, the bolt 480 extends in an upward direction through the base 360 and the locking lever 400, as will be further detailed below. Correspondingly, for example, the lug 330 does not have a cross beam or apertures in the sidewalls where a cross beam is received.

In this regard, referring still to FIG. 9, the base 360 has a raised block 490 having a square profile that is positioned between the mounting holes 370 and the sidewalls 380. In this way, the raised block 490 further defines the channel 355 in which the conductor 104 is installed while also separating the conductor 104 from the mounting hardware, which can reduce the risk of electrical interference or mechanical contact between the conductor 104 and fasteners used to secure the lug 330 to the palm 140. For example, the raised block 490 or the bolt 480 itself can act as a hard stop and a visual indicator to a user that the conductor 104 has been sufficiently installed within the channel 355. In some examples, the raised block 490 can be integrally formed with the base 360 during manufacturing, such as through extrusion or machining processes, to provide a unitary structure with enhanced rigidity, although other configurations are possible.

To help secure the locking lever 400 to the lug 330, the raised block 490 has a corresponding aperture 500 that receives the bolt 480, as will be further discussed below. In this example, the bolt 480 is shown in a loose configuration in which the bolt 480 is removably disposed within a countersunk hole in the base 360 (e.g., so that a wrench or other tool may be needed to prevent rotation of the bolt 480 during installation). In other examples, the bolt 480 is in a captive configuration. For example, the bolt 480 can be pressed during manufacturing into a countersink hole that has a profile and size that substantially matches the head of the bolt 480 or the bolt 480 can be pressed into a countersink hole that is slightly smaller than the head of the bolt 480. In some implementations, the countersink hole can include a non-circular profile, e.g., a hexagonal or square recess, that engages a correspondingly shaped bolt head to resist rotation during torque application. Such configurations, for example, can prevent rotation of the bolt 480 during installation (e.g., so that a separate tool may not be needed) or may prevent the bolt 480 from being accidentally removed during use or installation, although other configurations are possible.

Returning to FIG. 10, the locking lever 400 also includes a distal end 440, and a protrusion 450 between the proximal end 430 and distal end 440. In this embodiment, the protrusion 450 is off center between the proximal end 430 and the distal end 440. In particular, the protrusion 450 is positioned closer to the proximal end 430 than the distal end 440 than in previous examples disclosed above. The off-center positioning of the protrusion 450 increases the lever arm ratio for enhanced mechanical advantage, allowing greater clamping force to be applied to the conductor 104 for a given torque input at the bolt-engagement location, as described above and will be further detailed below.

To secure the locking lever 400 to the bolt 480, the locking lever 400 has a slot 510 (e.g., proximate the distal end 440), through which the bolt 480 is received. In this example, the slot 510 has an elongate profile that accommodates relative translation of the bolt 480 along the slot 510 as the locking lever 400 pivots, thereby helping the bolt 480 to maintain engagement with the locking lever 400 throughout the range of pivoting motion. However, other profiles of the slot 510 are possible (and similar profiles as shown for the slot 510 can be applied to other levers discussed herein).

Referring now to FIG. 11, the locking lever 400 is shown as being installed on the lug 330. For the sake of clarity, in this example, no conductor is shown, although it is understood that the conductor 104 in this embodiment would typically be disposed between the lever 400 and the base 360, and disposed within the channel 355. As illustrated, the bolt 480 is received through the aperture 500 of the raised block 490 and the slot 510 of the locking lever 400. To maintain the position of the locking lever 400, a nut 520 is secured onto the bolt 480 and abuts the locking lever 400. In this way, by advancing the nut 520 along the bolt 480, the nut 520 can provide a force that pivots a distal end of the locking lever 400 toward the base 360, so that the conductor 104 is secured to the base 360 by the locking lever 400.

In this example, to secure the conductor 104 to the base 360, the bolt 480 is first installed through the aperture 500 of the raised block 490. In some examples, this step can be performed during manufacturing such that this step is not required during installation. The conductor 104 can then be transversely inserted and positioned within the channel 355 either before, simultaneously with, or after the installation of the bolt 480 (e.g., with the bolt serving as a stop for the conductor 104, in some cases). The tabs of the proximal end 430 of the lever 400 can then be inserted within the slots 390 of the sidewalls 380 through the opening 410.

Once the conductor 104 is in a desired position, the lever 400 is then pivoted within the pivot opening 420 so that the slot 510 of the locking lever 400 is received onto the bolt 480 and the protrusion 450 is engaged with the conductor 104 to create a wedging force on the conductor 104. The nut 520 is then tightened onto the bolt 480 to secure the conductor 104 to the base 360, thereby helping to prevent the conductor 104 from being unintentionally removed from the lug 330, as similarly discussed above. In some examples, the nut 520 can be a locking nut or can be used in combination with a lock washer to resist loosening due to vibration or thermal cycling during operation, although other configurations are possible. Further, in comparison to examples above, the configuration of the lever 400 and the orientation and functional engagement of the bolt 480 can provide a lower overall profile of the lug 330 to save space as installed.

FIG. 12 shows another example of the locking lever 400 for use with the lug 330. In this example, the protrusion 450 of the locking lever 400 is positioned on the proximal end 430 of the lever 400 and below the oblong tabs. Accordingly, the protrusion 450 can secure the conductor 104 with a cammed engagement, when the lever 400 is pivoted. As illustrated, the protrusion 450 has a more bulbous profile, as compared with previous designs, which can create a uniform engagement with and distribute forces over a wider area of the conductor 104 when installed.

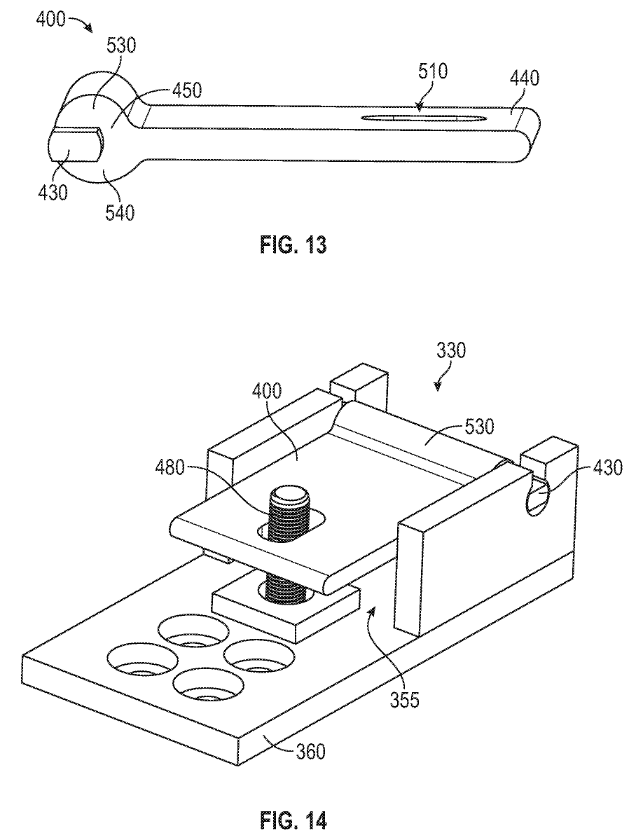

Turning now to FIG. 13, another example of the locking lever 400 according to another embodiment of the design is shown. As illustrated, the protrusion 450 has a bulbous profile that is disposed on the proximal end 430 and protrudes both above and below the oblong tabs. In particular, the protrusion 450 is unevenly distributed such that the protrusion 450 is divided into a first protrusion 530 and a second protrusion 540 relative to the tabs of the proximal end 430. Accordingly, the lever 400 is able to be selectively installed so that either of the first or second protrusions 530, 540 extends into the channel 355 to contact the conductor 104, depending on the size and shape of the conductor 104 or a degree of engagement desired, as will be further detailed below. In this example, the first protrusion 530has a larger and more steeply sloped extension from the tabs of the proximal end 430 as compared to the smaller and less steeply sloped extension of the second protrusion 540, although other configurations are possible.

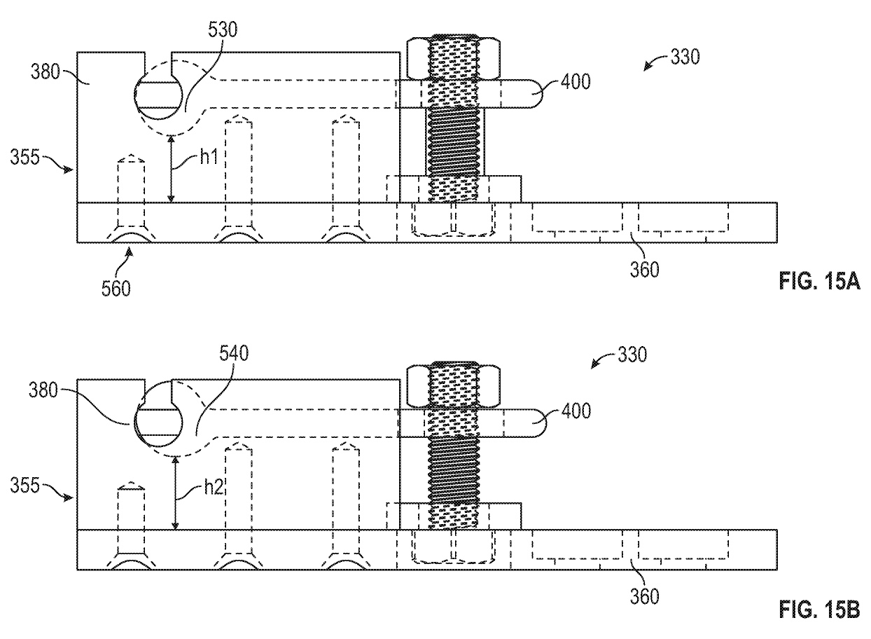

Referring now to FIGS. 15A and 15B, the locking lever 400 is shown as being installed in both configurations. In particular, turning specifically to FIG. 15A, the locking lever 400 is installed with the first protrusion 530 extending into the channel 355 to engage the conductor 104 when installed. In this example, a height the first protrusion 530 is spaced from the base 360 is defined by a height h1.

In contrast, as shown in FIGS. 14 and 15B, the second protrusion 540 extends into the channel 355 to engage the conductor 104 when installed. In this example, a height the second protrusion 540 is spaced from the base 360 is defined by a height h2. In this embodiment, height h2 is greater than the height h1 such that the locking lever 400 is configured to be installed with the second protrusion 540 engaging conductors that are thicker than conductors the first protrusion 530 engages.

The selection between the first protrusion 530 and the second protrusion 540 can be made during installation by simply reversing the orientation of the locking lever 400 within the slots 390, without requiring any additional hardware or modification to the lug 330. In this way, multiple conductors varying in size and profile can be installed using the same lug 330 and locking lever 400, thereby reducing the number of components or different types of connectors 330 needed for different conductors.

Referring still to FIGS. 15A and 15B, in this embodiment, the base 360 is manufactured separately from the sidewalls 380. For example, multiple screws (not shown) can be installed through corresponding mounting holes 560 of the base 360 to attach each sidewall 380 to the base 360. In this example, the attachment between the base 360 and the sidewalls 380 can be made permanent using welding, brazing, adhesive bonding, or other known manufacturing techniques. Generally, the base 360 and the sidewalls 380 can be pre-assembled for use, to minimize the amount of steps an end user is required to make for an installation. In other examples, the base 360 and the sidewalls 380 can be integrally formed as one component via extrusion and machining or other known manufacturing processes (e.g., to eliminate the need for assembly with screws), or otherwise configured.

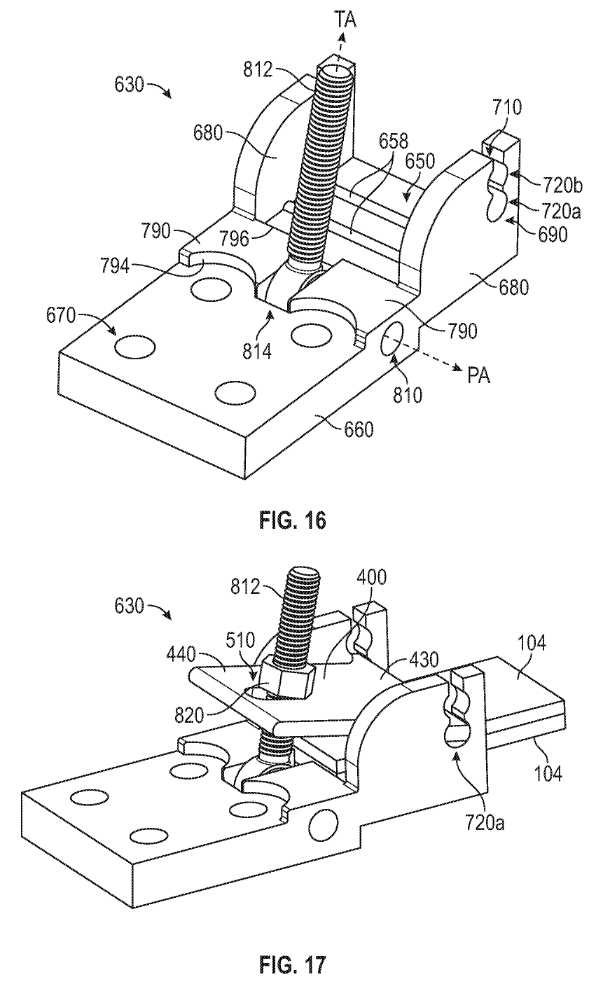

FIG. 16 shows a connector configured as a mechanical lug 630, as yet another example configuration of the connectors discussed above, configured in particular to secure one or more of the conductors 104 to a fixed installation, e.g., to secure one more free ends of the conductors 104 to the palm 140 (see FIG. 2). As shown, the lug 630 is generally similar to the lugs 130, 330, and discussion above of similarly numbered or named components also applies to the lug 630 unless otherwise indicated. For example, the lug 630 has a conductor channel 650, a base 660, and mounting holes 670 that can attach the lug 630 to the palm 140, corresponding to the conductor channel 150, the base 160, and the mounting holes 170 as discussed above.

To further enhance conductor retention, protrusions 658 (or other contoured surfaces) are positioned within the conductor channel 650. For example, the protrusions 658 can extend across a width of the channel 650 to enhance frictional engagement between the conductor 104 and the base 660 when the conductor 104 is installed. The protrusions 658 may have a round (as shown), pointed, half-hex-shaped, or other profile, and can improve the tensile pullout strength of the lug 630. In some examples, the protrusions 658 can be integrally formed with the base 660 during manufacturing, such as through extrusion or machining processes, although other configurations are possible. Correspondingly, although two protrusions 658 are shown, it should be understood that a greater or fewer amount of protrusions 658 can be used, such as one protrusion, three protrusions, or four protrusions, and the spacing between protrusions 658 can be selected based on the conductor size or the location of the protrusion 450 of the locking lever 400, although other configurations are possible.

Continuing, also similar to the lug 330, the lug 630 has laterally spaced sidewalls 680 that extend upwardly from the base 660 and have slots 690 that receive and secure tabs of a locking lever (e.g., any of the configurations of the locking levers 200, 400 discussed herein). The slots 690 have openings 710 out of the sidewalls 680, opposite corresponding pivot opening 720. Accordingly, the sidewalls 680 can receive and pivotally support a locking lever as generally discussed above.

Further, in this example, a plurality of pivot openings can be provided for each of the slots 690. For example, as shown in FIG. 16, the plurality of pivot openings includes two pivot openings 720a, 720b for each of the slots 690, which can be arranged in a stacked (e.g., vertically or substantially vertically stacked) configuration along the corresponding slot 690. Each pivot opening 720a, 720b has a bulbous profile that is larger than a width of the slot 690, thereby defining an enlarged recess configured to receive and retain – and pivotally support – the tabs of the proximal end of the locking lever 200, 400. In this example, the pivot opening 720b is positioned closer to the opening 710 of the slot 690, while the pivot opening 720a is positioned closer to the base 660 and forms a blind end of the slots 690. In some examples, the pivot openings 720a, 720b can be integrally formed during extrusion or machining of the sidewalls 680, although other configurations are possible.

This stacked arrangement of the pivot openings 720a, 720b along the slots 690 – or other arrangements with multiple pivot openings – can provide discrete, selectable pivot points at different spacings (e.g., heights) relative to the base 660. Correspondingly, the sidewalls 680 are configured to removably secure the locking lever 200, 400 with a pivot axis PA for the locking lever 200, 400 at any of a plurality of distances (e.g., heights) relative to the base 660.

In particular, during assembly, the tabs of the proximal end of the locking lever 200, 400 can be selectively received within either of the pivot openings 720a, 720b, depending on the thickness of the conductor 104 to be installed. For example, for thicker conductors, the tabs can be received within the pivot opening 720b, which provides a greater spacing between the locking lever 200, 400 and the base 660. In contrast, for thinner conductors, the tabs can be received within the pivot opening 720a, which provides a reduced spacing between the locking lever 400 and the base 660. Accordingly, the same connector 630 can accommodate a range of conductor sizes by selecting the appropriate pivot opening 720a, 720b for engagement with the locking lever 200, 400, and the vertical spacing between the pivot openings 720a, 720b can be selected based on the expected range of conductor thicknesses to be accommodated.

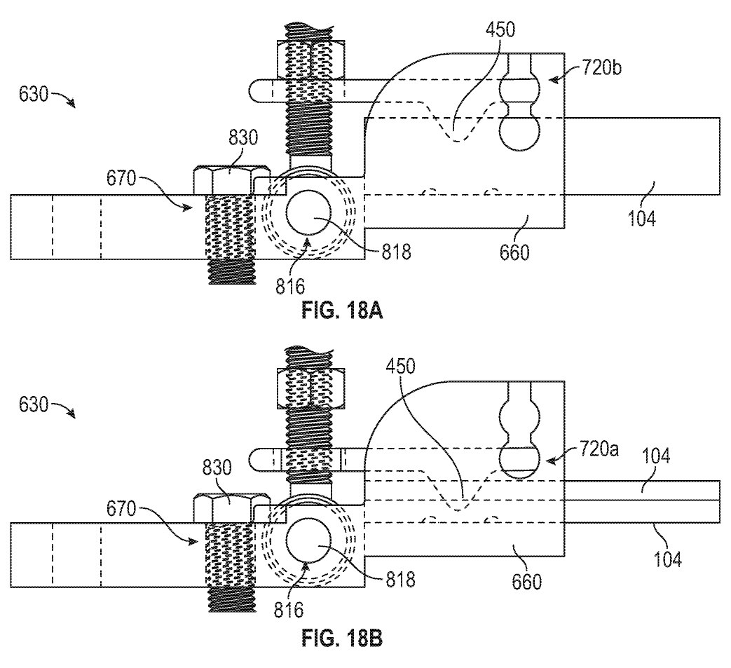

Referring still to FIG. 16, the base 660 includes raised blocks 790 that extend upwardly from the base 660 and are positioned between the mounting holes 670 and the sidewalls 680. As shown, each raised block 790 includes a cutout 794 (e.g., having a partial-circle profile) that opens toward the mounting holes 670. The profile of the cutout 794 is configured to receive a head of a fastener 830 (e.g., such as a bolt, see FIGS. 18A, 18B), allowing the fastener 830 to be seated within the raised block 790. In some examples, the cutout 794 can be integrally formed during extrusion or machining of the raised blocks 790, although other configurations are possible.

Additionally, the raised blocks 790 can define stops 796 that are machined or otherwise formed on a side of the raised block 790 opposite the cutout 794. The stops 796 can provide both visual and tactile feedback to a user, indicating that the conductor 104 has been sufficiently inserted within the conductor channel 650. In other words, the stops 796 can provide tactile indication of an insertion depth of the conductor 104 within the conductor channel 650. In this way, the stops 796 can also create a mechanical boundary that prevents the conductor 104 from contacting a bolt or other fastening hardware, which can help maintain proper clearance for operation of the assembly and reduce the risk of interference between the conductor 104 and the pivoting mechanism during clamping operations.

To allow secure clamping with the locking lever 400 within either of the pivot openings 720a, 720b, a thread fastener configured as a bolt 812 extends upwardly from the base 660 and through the locking lever 400 (see FIG. 17) when installed. As shown in FIG. 16, the bolt 812 is positioned between the raised blocks 790, extending out of an opening 814 in the base 660 between the blocks 790.

In particular, in this example, the bolt 812 is configured to pivot in a direction extending from the conductor channel 650 toward the mounting holes 670, and vice versa. This pivoting capability can be achieved, for example, via a proximal aperture 816 of the bolt 812 (see FIGS. 18A, 18B) that is aligned with an opening 810 that extends through the raised block 790 and correspondingly defines a pivot axis for the bolt 812.

To secure the bolt 812 to the base 660 for pivoting movement, the aperture 816 of the bolt 812 can be aligned with the opening 810 of the raised blocks 790 to receive a fastener 818. In particular, the fastener 818 extends through the aligned opening 810 and aperture 816, thereby providing a pivot body about which the bolt 812 can rotate. Thus, as will be further detailed below, the bolt 812 can pivot during installation about a pivot axis PA that is perpendicular to a thread axis TA along which the bolt extends (i.e., the axis along which a nut screwed onto the bolt would move). In some examples, the fastener 818 can be configured as a rod, as shown in FIGS. 18A, 18B, or as another pivot member. In some cases, the fastener 818 can be secured in place by a set screw or by a retaining feature formed in the base 660, or by press-fitting the fastener 818 into the opening 810. In other examples, the fastener 818 can be configured as a clevis pin with a cotter pin or retaining ring to prevent axial withdrawal.

In some cases, to allow for improved pivoting motion, the base 660 can include a stepped profile. In particular, the base 660 – including the mounting holes 670 and raised blocks 790 – is relatively thick as compared to other portions of the connector 630 (e.g., as compared to the base wall of the channel 650). This configuration allows the aperture 816 of the bolt 812 to be seated within the opening 814 of the base 660, and freely pivot within the base 660, without protruding below a bottom surface of the base 660. Thus, for example, the beneficial pivoting of the bolt 812 may remain unimpeded when the connector 630 is installed (e.g., onto a palm, etc.). Correspondingly, to provide a part with less material, the base wall of the conductor channel 650 can be thinner than the opposed portion of the base 660 (e.g., that receives the bolt 812 and the fastener 830).

Referring now to FIG. 17, the locking lever 400 is shown installed, to secure the conductor 104 (e.g., of either of two sizes, shown in overlay). As similarly discussed for preceding examples, the proximal end 430 of the locking lever 400 can be first received within the pivot opening 720 of the sidewalls 680 (e.g., opening 720a, as shown), to removably secure the locking lever 400 for pivoting movement. The bolt 812 may then be received through the slot 510 of the locking lever 400 (see, e.g., FIG. 17). A nut 820 can be further secured onto the bolt 812 and abut a top surface of the locking lever 400.

With this arrangement, as a user advances the nut 820 along the bolt 812, the locking lever 400 and the bolt 812 can both pivot. Accordingly, the conductor 104 can be progressively secured to the base 660 by the locking lever 400, as the locking lever 400 is urged into engagement by the progression of the nut 820 along the bolt 812. Further, due to the pivoting of the bolt 812 relative to the base 660, the bolt 812 may be maintained in perpendicular (i.e., threading) alignment with the nut 820, so that bending of the bolt 812 or cross-threading of the nut 820 may be generally avoided.

FIGS. 18A and 18B illustrate the locking lever 400 in two installed configurations for accommodating conductors 104 of different thicknesses. In FIG. 18A, the locking lever 400 is shown received within the pivot opening 720b, in a first installed pivot location, to secure thicker conductors, as noted above. In FIG. 18B, the locking lever 400 is shown received within the pivot opening 720a, in a second installed pivot location, to secure thinner conductors (e.g., of either of two sizes, as shown in overlay). In both configurations, the protrusion 450 of the locking lever 400 extends downward (e.g., relative to the base 660) to engage and clamp the conductor 104 against the base 660. The fastener 818 extends through openings 810 of the raised blocks 790 and the aperture 816 of the bolt 812, as noted above, to secure the bolt 812 to the base 660 while still allowing the bolt 812 to pivot relative to the base 660. Further shown in this example, the fastener 830 is received within one of the mounting holes 670 (e.g., to secure the base 660 to a palm (not shown)) and is substantially at a same height level as the base 660 of the channel 650.

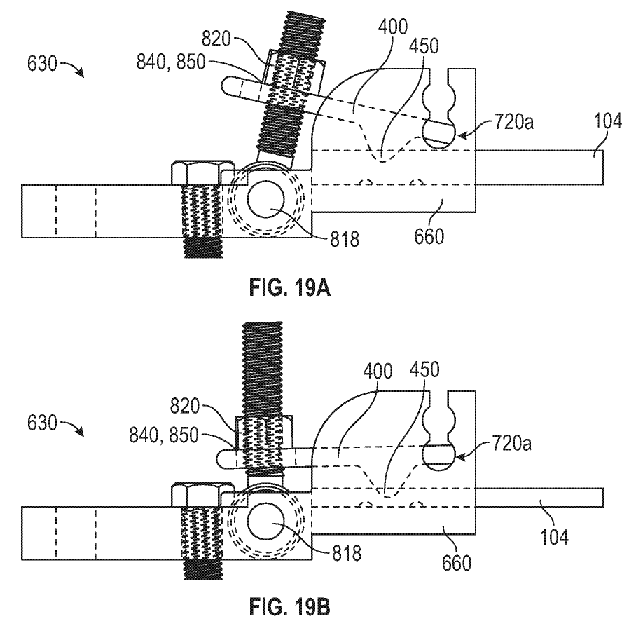

FIGS. 19A and 19B illustrate a particular pivoted orientations of the locking lever 400, with maintained alignment with the nut 820 during installation to secure conductors 104 of different thicknesses. In the illustrated examples, the locking lever 400 is installed within pivot opening 720a, although similar movement may also result from the alternative installed configuration of the locking lever 400 (e.g., to accommodate conductors 104 of larger thicknesses).

As shown in FIG. 19A, the locking lever 400 secures a relatively thicker conductor 104, while FIG. 19B shows the locking lever 400 securing a relatively thinner conductor 104. In both cases, as the locking lever 400 is advanced downward toward the base 660, the bolt 812 rotates about a pivot defined by the fastener 818 (e.g., with the fastener 818 remaining fixed relative to the raised blocks 790, to allow the bolt 812 to pivot about the aperture 816). This pivoting action of the bolt 812 causes an axial direction of the bolt 812 to remain substantially perpendicular with a top surface 850 of the locking lever 400 and, correspondingly, with a mating surface 840 of the nut 820. As illustrated in both FIGS. 19A and 19B, this parallel (or substantially parallel) alignment between the mating surface 840 and the top surface 850, and the corresponding perpendicular (or substantially perpendicular) alignment of the bolt 812 can be maintained regardless of the angular position of the locking lever 400 during operational use. Accordingly, this mechanical arrangement can advantageously help prevent cross-threading of the nut 820 and bending of the bolt 812 during torque application, which can otherwise occur in fixed-bolt configurations, where the bolt cannot pivot to accommodate the changing angle of the locking lever 400.

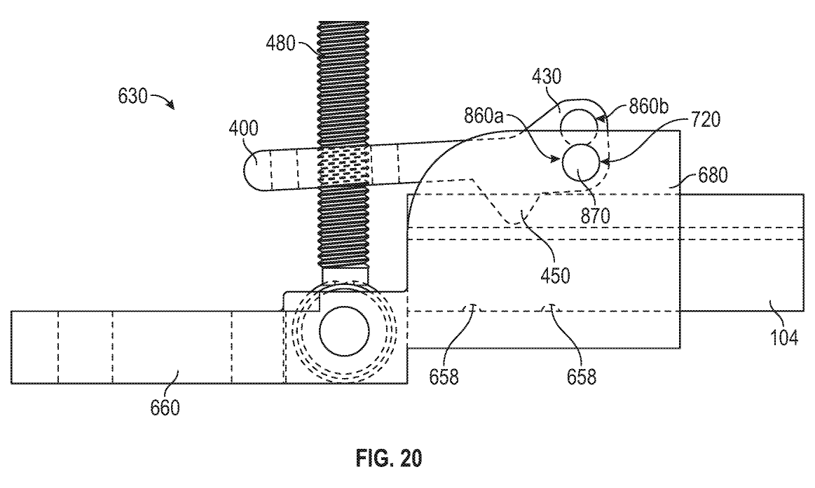

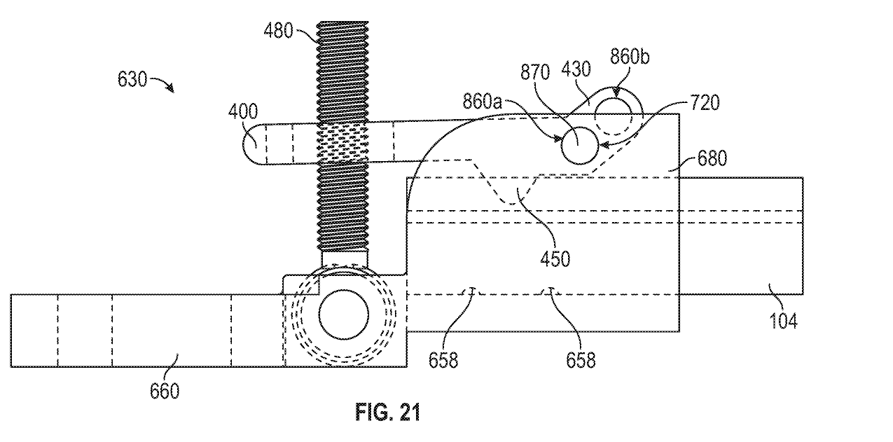

FIGS. 20 and 21 illustrate alternative configurations of the locking lever 400 in which the pivot openings 860a, 860b are formed directly on the locking lever 400, rather than on the sidewalls 680. Correspondingly, the oblong tabs previously described on the proximal end 430 of the locking lever 400 can be eliminated. Instead, for example, one of the pivot openings 860a or 860b on the locking lever 400 is selectively aligned with the pivot opening 720 on the sidewalls 680, depending on the thickness of the conductor 104 to be secured. A pin 870 can be inserted through the aligned openings (i.e., selectively through either pivot opening 860a or 860b and through the pivot openings 720) to secure the locking lever 400 for pivoting movement relative to the base 660. In this example, the pin 870 is configured as a stainless-steel clevis pin, which allows for a high pullout load, although other configurations and materials are possible.

In the example shown in FIG. 20, the pivot openings 860a, 860b are arranged in a vertically stacked configuration, as viewed with the locking lever 400 secured to the sidewalls 680 and extending in an elongate direction in parallel (or substantially parallel) with the base 660. In this arrangement, the rotation path of the locking lever 400 is generally the same no matter which pivot opening 860a or 860b is utilized. Generally, however, this stacked arrangement allows the locking lever 400 to accommodate conductors of different thicknesses while maintaining a relatively consistent pivot path for the locking lever 400. For example, the pivot opening 860a is positioned closer to the protrusion 450 of the locking lever 400 and can thus be selected for use with thicker conductors, while the pivot opening 860b is positioned farther from the protrusion 450 and can thus be selected for use with thinner conductors. Correspondingly, for example, through selection of the appropriate pivot opening 860a, 680b, the protrusion 450 can be aligned to generally contact conductors of a wide range of thicknesses at a location that is between the protrusions 658 (e.g., for a similar enhancement of retention by the protrusions 658 for all installed configurations).

In the examples shown in FIG. 21, the pivot openings 860a, 860b are arranged in a diagonally staggered configuration, such that the rotation path of the locking lever 400 is more varied depending on whether the pivot opening 860a or 860b is utilized. In this arrangement, the pivot opening 860a is positioned closer to the protrusion 450 and can be selected for use with thicker conductors, while the pivot opening 860b is positioned farther from the protrusion 450 and can be selected for use with thinner conductors. This diagonally staggered configuration allows the locking lever 400 to accommodate conductors of different thicknesses by providing two distinct pivot points at different positions along the locking lever 400. In particular, when the pivot opening 860a is selected, the locking lever 400 rotates about a first pivot point positioned closer to the protrusion 450, which may be suitable for thicker conductors. When the pivot opening 860b is selected, the locking lever 400 rotates about a second pivot point positioned farther from the protrusion 450, which may be suitable for thinner conductors. Accordingly, the staggered arrangement of the pivot openings 860a, 860b allows for targeted adjustment of the clamping geometry of the locking lever 400 relative to the conductor 104 based on conductor thickness requirements. The staggered arrangement of the openings 860a, 860b can also allow for relatively thicker material between the openings 860a, 860b (e.g., as compared to the configuration of FIG. 20), with corresponding improvements for durability and manufacturing. In some examples, the diagonal spacing can be selected to position each pivot opening 860a, 860b at a location along the locking lever 400 that optimizes the lever arm ratio for the corresponding conductor thickness range, thereby providing enhanced mechanical advantage during torque application for both thicker and thinner conductor installations.

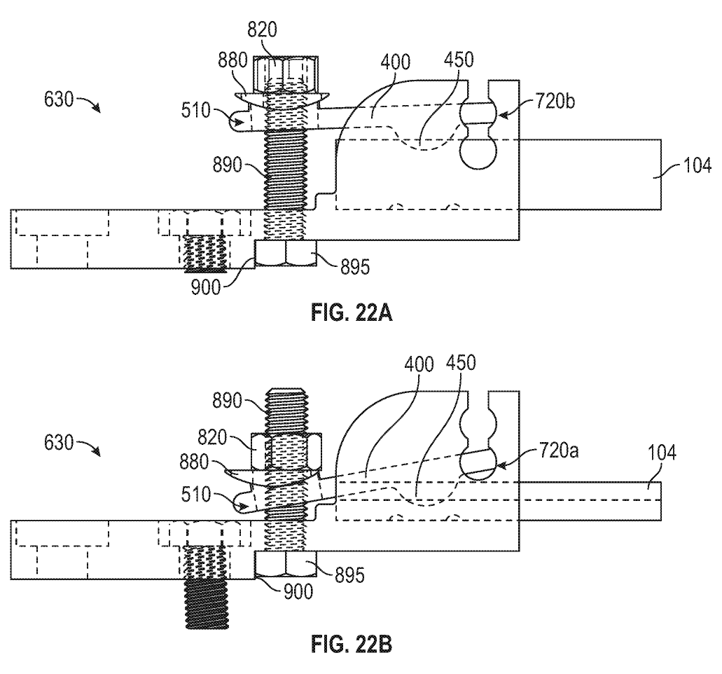

FIGS. 22A and 22B illustrate an alternate configuration of the connector 630 that can include a washer 880 to maintain threaded alignment between the nut 820 and a bolt 890 (e.g., a non-pivoting bolt, as shown). In particular, FIG. 22A shows the locking lever 400 received within the pivot opening 720b, while FIG. 22B shows the locking lever 400 received within the pivot opening 720a. In particular, the washer 880 is positioned between the nut 820 and the locking lever 400 to provide a mating surface for the nut 820 that can pivot with movement of the locking lever 400. Thus, the washer 880 can support the nut 820 in appropriate alignment relative to the bolt 890 over the range of motion of the locking lever 400. In this example, the washer 880 can be formed from a low-friction material, such as bronze, nylon, or a polymer composite, to facilitate smooth relative movement between the washer 880 and the locking lever 400 during clamping operations.

As shown, the slot 510 of the locking lever 400 is aligned with a raised portion of the lever 400, which includes a disc-shaped recess (e.g., a trough, with a partial circle side profile, as shown). Also as shown, the recess can receive the washer 880, with the washer 880 disposed between the nut 820 and the locking lever 400. As the nut 820 is tightened along the bolt 890, the washer 880 slides within the slot 510 (e.g., left to right, as shown) to accommodate the changing angle of the locking lever 400. In particular, this sliding movement allows the parallel (or substantially parallel) alignment between the mating surfaces of the nut 820 and the washer 880 to be maintained as the lever 400 is pivoted away from parallel, thus helping to prevent cross-threading of the nut 820 or bending of the bolt 890 during torque application. The raised portion surrounding the disc-shaped recess can also help retain the washer 880 within the slot 510, thereby preventing unwanted displacement of the washer 880 during clamping operations. In this way, for example, the washer 880 can provide an alternative mechanism to the pivoting bolt design described above for maintaining proper alignment between the fastening components during installation.

To provide clearance for a head 895 of the bolt 890 when installed onto the connector 630, the base 660 as shown in FIGS. 22A and 22B has a stepped profile, with the base wall of the conductor channel 650 offset (e.g., elevated) relative to the rest of the base 660. In particular, the elevation of the conductor channel 650 allows the head 895 of the bolt 890 to be installed onto the connector 630 without protruding below a bottom surface of the base 660 (e.g., as might impede securing the connector 630 onto the palm 140). This flush mounting arrangement can be particularly advantageous in installations where the connector 630 must be secured against a flat mounting surface with minimal clearance, such as within enclosed electrical cabinets or when multiple connectors are positioned in close proximity on a shared mounting rail. Further, an end face 900 corresponding to the offset configuration of the conductor channel 650 can also serve as a hard stop to prevent the bolt 890 from rotating while torque is applied to the nut 820. In some examples, the end face 900 can have a flat or other contoured profile that engages a corresponding flat (or other) surface on the head 895 of the bolt 890 and thereby provides anti-rotation restraint through direct mechanical contact, although other configurations are possible. Thus, for example, engagement of the end face 900 with the bolt 890 can eliminate the need for an additional tool to hold the bolt 890 in place during installation. In some examples, the profile of the base 660 can be extruded during the manufacturing process to include the end face 900, which may favorably eliminate a machining operation that would otherwise be required to create a recessed hole to receive the bolt head 895.

Thus, lug and splice assemblies according to the disclosed technology can provide improved adaptability to particular site needs, including to securely connect two or more low voltage conductors together between a transformer and one or more other electrical components. Further, some examples can be assembled in a modular fashion (e.g., with a pre-assembled connection assembly, minus the conductors to be spliced), with corresponding improvements in flexibility and efficiency. Additionally, the connector and associated locking lever configurations can provide enhanced versatility through features such as selectable pivot openings for accommodating conductors of varying thicknesses, pivoting bolt arrangements that maintain parallel (or substantially parallel) alignment between the nut and the locking lever to prevent cross-threading and bolt bending, and alternative washer configurations that similarly maintain proper alignment during torque application. The raised blocks with partial-circle cutouts and hard stops, along with protrusions within the conductor channel, can further enhance conductor retention and installation feedback.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise limited or defined, “integral” and derivatives thereof (e.g., “integrally”) describe elements that are manufactured as a single piece without fasteners, adhesive, or the like to secure separate components together. For example, an element stamped or cast as a single-piece component from a single piece of sheet metal or a single mold (etc.), without rivets, screws, or adhesive to hold separately formed pieces together, is an integral (and integrally formed) element. In contrast, an element formed from multiple pieces that are separately formed initially, then later connected together, is not an integral (or integrally formed) element.

Also as used herein, unless otherwise specified or limited, “substantially parallel” indicates a direction that is within ± 12 degrees of a reference direction (e.g., within ± 6 degrees or ± 3 degrees), inclusive. Similarly, unless otherwise specified or limited, “substantially perpendicular” similarly indicates a direction that is within ± 12 degrees of perpendicular to a reference direction (e.g., within ± 6 degrees or ± 3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Also as used herein, unless otherwise defined or limited, directional terms are used for convenience of reference for discussion of particular figures or examples or to indicate spatial relationships relative to other specified components or context, but are not intended to necessarily indicate absolute orientation. For example, references to downward, forward, right, left, or other directions, or to top, rear, right, left or other positions (or features) may be used to discuss aspects of a particular example or orientation (e.g., as shown in a particular figure), but do not necessarily require similar orientation or geometry in all installations or configurations.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order. Relatedly, similar or identical components may be referred to with different ordinal numbers in different contexts.

In some implementations, devices or systems disclosed herein can be utilized, manufactured, installed, etc. using methods embodying aspects of the disclosed technology. Correspondingly, unless otherwise indicated, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated, discussion herein of any method of manufacturing or using for a particular device or system, including installing the device or system, should be understood to disclose, as examples of the disclosed technology, the utilized features and implemented capabilities of such device or system.

The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

What is claimed is:

1. An assembly for securing a conductor, the assembly comprising:
a lug, including:
a base; and
sidewalls extending from the base to define a conductor channel that extends along the base between first and second ends of the conductor channel;
a locking lever having a proximal end that engages the sidewalls to secure the locking lever to be pivotable relative to the base; and
a threaded fastener secured to the base and extending through a distal end of the locking lever to provide a force that pivots the distal end of the locking lever towards the base, to secure the conductor within the conductor channel.

2. The assembly of claim 1, wherein the locking lever is removably secured to the sidewalls;
wherein the conductor channel has an open side between the sidewalls, opposite the base, to receive the conductor via a lay-in installation when the locking lever is removed from the sidewalls.

3. The assembly of claim 1, wherein the sidewalls include a first sidewall with a first slot and a second sidewall with a second slot, the first and second slots receiving the locking lever to removably secure the locking lever to the sidewalls.

4. The assembly of claim 3, wherein the sidewalls have a plurality of pivot locations arranged along each of the first and second slots; and
wherein the locking lever is selectively securable to the first and second sidewalls at a selected pivot location of the plurality of pivot locations, to selectively space a pivot axis of the locking lever at a respective distance of a plurality of different distances from the base.

5. The assembly of claim 1, wherein the locking lever includes a plurality of pivot openings, and
wherein the locking lever is selectively securable to the sidewalls at a selected pivot opening of the plurality of pivot openings, to selectively space a cam protrusion of the locking lever at a respective distance of a plurality of different distances from the base.

6. The assembly of claim 5, wherein the plurality of pivot openings on the locking lever are arranged in one of a vertically stacked configuration or a diagonally staggered configuration, as viewed with the locking lever secured to the sidewalls and extending in an elongate direction substantially in parallel with the base.

7. The assembly of claim 1, wherein the locking lever includes a protrusion that engages the conductor to clamp the conductor onto the base.

8. The assembly of claim 7, wherein the protrusion extends from the proximal end of the locking lever.

9. The assembly of claim 1, wherein the base defines a hard stop between the threaded fastener and the conductor channel, to provide tactile indication of an insertion depth of the conductor within the conductor channel.

10. The assembly of claim 1, wherein the threaded fastener is pivotable relative to the base, about an axis transverse to a thread axis of the threaded fastener, as the threaded fastener pivots the locking lever to clamp the conductor within the conductor channel.

11. An assembly for securing a conductor, the assembly comprising:
a lug including a base and sidewalls that define a conductor channel configured to receive a conductor so that an axis of the conductor extends along a first direction between first and second ends of the conductor channel, the conductor channel being open to receive the conductor into the conductor channel via movement of the conductor into the conductor channel transverse to the first direction; and
a locking lever rotatable relative to the sidewalls to clamp the conductor onto the base within the conductor channel.

12. The assembly of claim 11, wherein the locking lever is removably secured to the lug to extend between the sidewalls and close the conductor channel on an opposite side of the conductor from the base.

13. The assembly of claim 11, wherein sidewalls are configured to removably secure the locking lever with a pivot axis for the locking lever at any of a plurality of distances from the base.

14. The assembly of claim 11, further comprising:
a threaded fastener extending from the base through the locking lever and configured to urge the locking lever to pivot relative to the sidewalls to clamp the conductor onto the base.

15. The assembly of claim 14, wherein the threaded fastener defines a thread axis, and is pivotably secured to the base about a pivot axis transverse to the thread axis.

16. A method for securing a conductor, the method comprising:
providing a lug that includes a base and sidewalls extending from the base to define a conductor channel that extends along the base between first and second ends of the conductor channel;
inserting the conductor into the conductor channel;
engaging a proximal end of a locking lever with the sidewalls to secure the locking lever for pivoting movement relative to the base; and
using a threaded fastener that is secured to the base and extends through a distal end of the locking lever, providing a force that pivots the distal end of the locking lever towards the base to secure the conductor within the conductor channel.

17. The method of claim 16, wherein inserting the conductor into the conductor channel includes moving the conductor into the conductor channel transverse to a first direction between the first and second ends of the conductor channel, so that an axis of the conductor extends along the first direction.

18. The method of claim 16, wherein engaging the proximal end of the locking lever with the sidewalls includes inserting the proximal end of the locking lever into slots of the sidewalls.

19. The method of claim 18, wherein engaging the proximal end of the locking lever with the sidewalls includes selectively positioning the locking lever at either of a first pivot location or a second pivot location along at least one of the slots.

20. The method of claim 16, wherein using the threaded fastener to provide the force:
includes threadedly engaging the threaded fastener to provide the force; and
causes the threaded fastener to pivot relative to the base about an axis transverse to a thread axis of the threaded fastener.
